(19) United States
(12) Patent Application Publication
(10) Pub. No.: US 2005/0124360 A1
(43) Pub. Date: Jun. 9, 2005

(54) Mobile phone capable of deleting sent short message stored in receiver's mobile phone and method of transmitting and deleting short message using the same

(75) Inventor: Jong-Ho Choi, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/924,325

(22) Filed: Aug. 23, 2004

(30) Foreign Application Priority Data
Dec. 8, 2003 (KR) 88704-2003

(51) Int. Cl. H04Q 7/00

(52) U.S. Cl. 455/466

(57) ABSTRACT

A mobile phone capable of deleting a sent short message stored in a receiver's mobile phone and a method of transmitting and deleting a short message using the same are provided. In a method of transmitting and deleting a short message, a sender's mobile phone generates a short message, transmits it, and stores its transmission-related information. A receiver's mobile phone stores the short message. The sender's mobile phone transmits a delete request message to the receiver's mobile phone, requesting deletion of the short message. The receiver's mobile phone searches for the short message in response to the delete request message and deletes the short message from a storage area.

### PRIORITY

This application claims priority under 35 U.S.C. § 119 to an application entitled “Mobile Phone Capable of Deleting Sent Short Message Stored in Receiver's Mobile Phone and Method of Transmitting and Deleting Short Message Using the Same” filed in the Korean Intellectual Property Office on Dec. 8, 2003 and assigned Serial No. 2003-88704, the contents of which are incorporated herein by reference.

### BACKGROUND OF THE INVENTION

1. Field of the Invention

The present invention relates generally to a method for deleting a short message in a mobile phone, and in particular, to a method for enabling a sender to delete a short message sent to a receiver.

2. Description of the Related Art

Along with the development of mobile communication technology, a mobile phone has been equipped with a variety of functions. One in particular is a short message service (SMS) that transmits a short message over a mobile communication network, which has been so popular that almost all mobile subscribers enjoy the SMS.

As the number of Internet sites that provide the SMS has recently increased, short messages can be transmitted to multiple users more conveniently. For example, a short message can be written using a computer keyboard rather than a mobile phone that provides a limited interface, and if an identical short message is to be transmitted to a plurality of users, receivers can be easily selected. Also, a short message transmission reservation service is provided to transmit a written short message at a desired point in time.

However, in the case where a sender transmits a short message to a unintended receiver, there are no current methods for the sender to unsend the unintended short message. Hence, the receiver reads the unintended short message, which is a waste of time. Moreover, the receiver's mobile phone must store the short unintended message until the receiver reads the short message, resulting in a waste of memory capacity.

### SUMMARY OF THE INVENTION

An object of the present invention is to substantially solve at least the above problems and/or disadvantages and to provide at least the advantages below. Accordingly, an object of the present invention is to provide a method of eliminating the time involved with reading an unintended short message for a receiver and saving memory capacity in the receiver's mobile phone.

Another object of the present invention is to provide a method of enabling a sender to delete an unintended short message sent by the sender.

A further object of the present invention is to provide a mobile phone capable of deleting a short message sent to a receiver and stored in the receiver's mobile phone.

Still another object of the present invention is to provide a mobile communication system where a sender's mobile phone can be used to delete a short message sent to and stored in a receiver's mobile phone.

The above objects are achieved by providing a mobile phone capable of deleting a sent short message stored in a receiver's mobile phone and a method of transmitting and deleting a short message using the same are provided.

According to one aspect of the present invention, in a method of transmitting and deleting a short message, a sender's mobile phone generates a short message, transmits it, and stores its transmission-related information. A receiver's mobile phone stores the short message. The sender's mobile phone transmits a delete request message to the receiver's mobile phone, requesting deletion of the short message. The receiver's mobile phone searches for the short message in response to the delete request message and deletes the short message from a storing area.

According to another aspect of the present invention, in a mobile phone having a storage area for storing received short messages therein, a receiver receives a delete request message for a short message from a sender's mobile phone that transmitted the short message, and a controller searches for the short message in the memory in response to the delete request message and controls deletion of the short message.

According to a further object of the present invention, in a mobile phone for generating a short message, transmitting the short message, and storing transmission-related information related to the short message, a memory stores transmission-related information related to sent short messages therein, a controller generates a delete request message requesting deletion of a sent short message according to user selected information, and a transmitter transmits the delete request message to a receiver's mobile phone that received the sent short message.

According to still another object of the present invention, in a mobile communication system, a sending mobile phone generates a delete request message requesting deletion of a sent short message based on user selected information and transmits the delete request message. A receiving mobile phone stores short messages received over a mobile communication network, and deletes the sent short message whose deletion is requested among the stored short messages in response to the delete request message.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a signal flow for performing a method of transmitting and deleting a short message according to an embodiment of the present invention;

FIG. 2 is a diagram illustrating the format of an outgoing short message according to the embodiment of the present invention;

FIG. 3 is a table illustrating a method of managing outgoing short messages in a sender's mobile phone according to the embodiment of the present invention;

FIG. 4 is a table illustrating a method of managing incoming short messages in a receiver's mobile phone according to the embodiment of the present invention;

FIG. 5 is a diagram illustrating the format of a message delivered to delete a short message according to the embodiment of the present invention;

FIG. 6 is a flowchart illustrating an operation in a sender's mobile phone for deleting a short message stored in a receiver's mobile phone according to the embodiment of the present invention;

FIG. 7 is a flowchart illustrating an operation in a receiver's mobile phone for deleting a received short message according to the embodiment of the present invention; and

FIG. 8 is a block diagram of a mobile phone according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

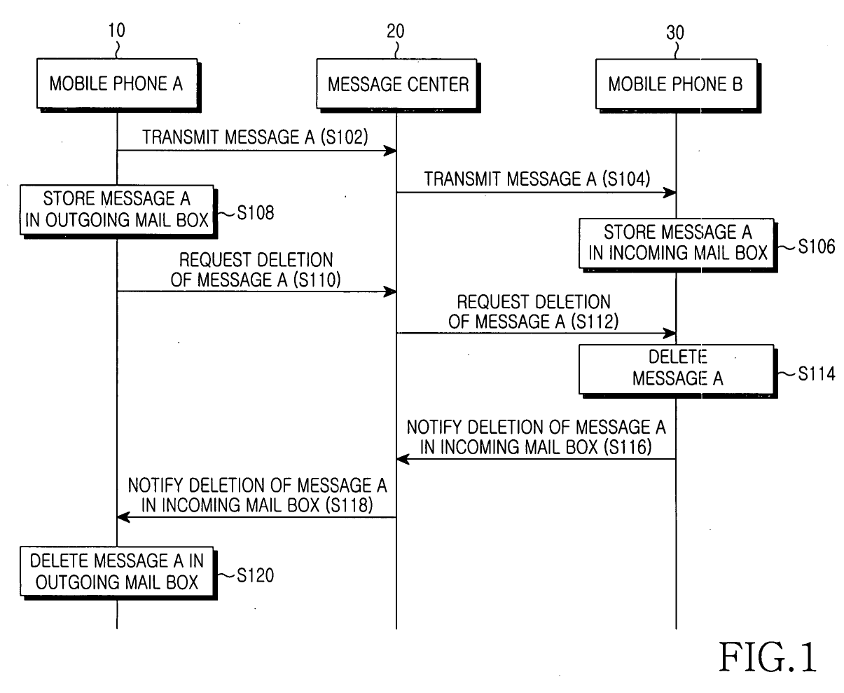

FIG. 1 is a diagram illustrating a signal flow for performing a method of transmitting and deleting a short message according to an embodiment of the present invention. In the case illustrated in FIG. 1, a mobile phone 10 (mobile phone A) is a sender's mobile phone for sending a short message and a mobile phone 30 (mobile phone B) is a receiver's mobile phone for receiving the short message. With reference to FIG. 1, the transmission and the deletion of a short message according to the embodiment of the present invention will be described.

The sender writes message A and requests mobile phone A to transmit message A to mobile phone B. Mobile phone A then transmits message A to mobile phone B via a message center 20 in steps S102 and S104. Upon receipt of message A, mobile phone B stores message A in an incoming message storing area (e.g. an incoming mail box) in step S106. Mobile phone A also stores message A in an outgoing message storing area (e.g., an outgoing mail box) in step S108.

When the sender requests via the message center 20 mobile phone B to delete message A in step S110 and S112, mobile phone B deletes message A from its incoming mail box in step S114 and notifies via the message center 20 mobile phone A of the deletion of message A in steps S116 and S118.

Before deleting message A, mobile phone B determines if message A has been read. It is preferable for mobile phone B to delete message A only if it is not read. If the receiver has already read message A, mobile phone B preferably notifies mobile phone A that it cannot delete message A, and message A is not deleted.

In step S120, mobile phone A preferably deletes message A from its outgoing mail box.

To support the above-described operation, the short message transmitted between mobile phone A and mobile phone B preferably contains a message ID (Identification). The message ID is used to identify one short message from another.

The short message delete function can be provided as an option in a mobile phone so that a user can selectively use the function. That is, mobile phone B is allowed to determine whether or not to support the delete function and when mobile phone B rejects the delete function, deletion of message A is not allowed in mobile phone B even if mobile phone B receives a delete request for message A from mobile phone A. In this case, mobile phone B preferably notifies mobile phone A of the rejection of the delete request.

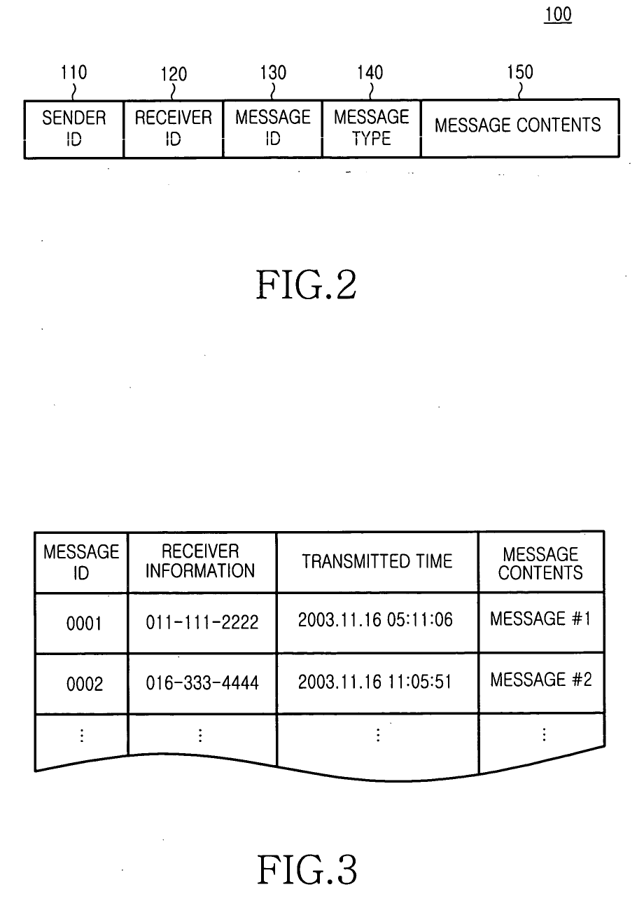

FIG. 2 illustrates the format of an outgoing short message 100 according to the embodiment of the present invention. Referring to FIG. 2, the outgoing short message 100 contains a sender ID 110, a receiver ID 120, a message ID 130, a message type 140, and a message contents 150.

The sender ID 110 is a number that identifies a short message sender (e.g., phone number). The receiver ID 120 is a number that identifies a short message receiver (e.g., phone number). The message ID 130 is a number that identifies the short message. It is needed to select a short message to be deleted from the sender's mobile phone and the receiver's mobile phone. It is preferred that a unique message ID specific to a short message is produced when the short message is generated in the sender's mobile phone. How the sender's mobile phone and the receiver's mobile phone use the message ID will be described later in detail with reference to FIG. 5.

The message type 140 indicates if the short message is a delete request message. Thus, the message type 140 is preferably set to indicate a typical short message or a delete request message. The sender ID 110, the receiver ID 120, the message ID 130 and the message type 140 correspond to the header information of the short message. The actual data of the short message is contained in the message contents 150.

The sender's mobile phone generates short message data as illustrated in FIG. 2, transmits it to the receiver's mobile phone, and then stores it in an outgoing mail box in the sender's mobile phone.

FIG. 3 is a table illustrating a method of managing outgoing short messages in a sender's mobile phone according to the embodiment of the present invention. Referring to FIG. 3, the sender's mobile phone stores and manages the message IDs, receiver information, transmitted time, and message contents of outgoing short messages in the outgoing mail box.

If the sender wants to check a sent message, the sender's mobile phone retrieves the receiver information, transmitted time, and message contents of the message from the outgoing mail box and displays them. When many outgoing short messages are in the outgoing mail box, the sender's mobile phone labels them with sequential numbers and displays them with the sequential numbers. The sequential numbers can be message IDs, although it is not necessary that the message IDs are always sequential numbers.

Meanwhile, the receiver's mobile phone receives the short message data illustrated in FIG. 2 and stores it in the incoming mail box.

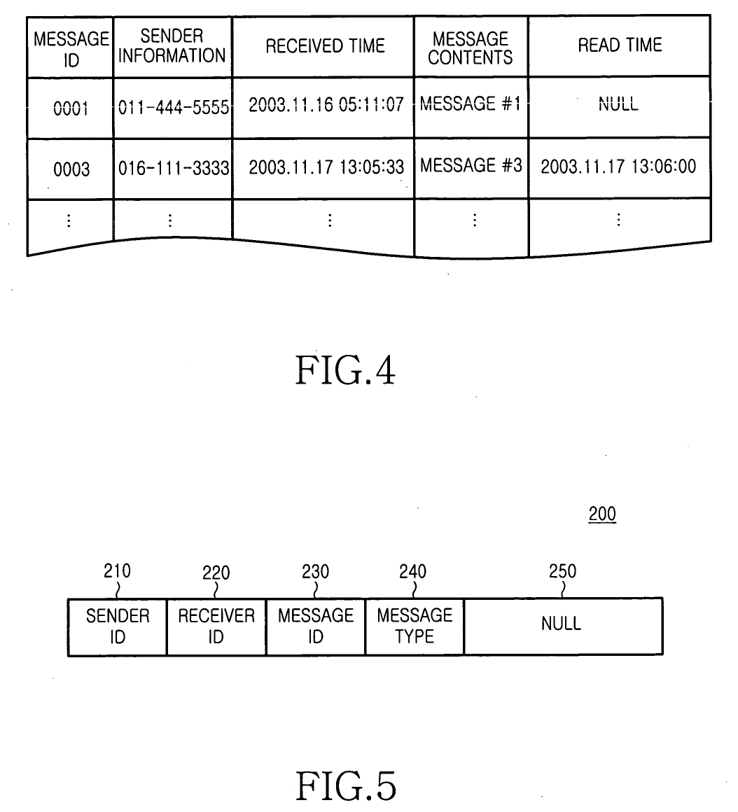

FIG. 4 is a table illustrating a method of managing incoming short messages in a receiver's mobile phone according to the embodiment of the present invention. Referring to FIG. 4, the receiver's mobile phone stores and manages the message IDs, sender information, received time, and message contents of incoming short messages in the incoming mail box. For a received message which the receiver has not read, “NULL” is preferably stored in a read time storing area to thereby indicate that the received message is left unread.

Each time the receiver's mobile phone receives a short message, it stores and manages information about the short message in an incoming mail box. If the receiver wants to read the short message, the receiver's mobile phone retrieves the sender information, received time, message contents, and a time the message was first read from the incoming mail box and displays them. When many incoming short messages are in the incoming mail box, the receiver's mobile phone labels them with sequential numbers and displays them with the sequential numbers. The sequential numbers can be message IDs, although it is not necessary that the message IDs are always sequential numbers.

FIG. 5 illustrates the format of a message 200 transmitted to delete a short message (e.g., a delete request message) according to the embodiment of the present invention. Referring to FIG. 5, the delete request message 200 is formatted like the short message illustrated in FIG. 2, except that NULL is filled in a message contents area 250. This is because both the sender's mobile phone and the receiver's mobile phone manage the message ID of each short message in managing the outgoing mail box and the incoming mail box.

Thus, when the sender's mobile phone generates a delete request message containing the message ID of a short message to be deleted as illustrated in FIG. 5 and transmits it to the receiver's mobile phone, the receiver's mobile phone selects a short message having the same message ID and sender's ID as set in the delete request message and deletes the selected short message.

The short message deletion according to the present invention will be described in more detail with reference to FIGS. 3, 4 and 5. A sender's mobile phone having a phone number of “011-444-5555” selects an outgoing message having a message ID of “0001” from its outgoing mail box as illustrated in FIG. 3, generates a delete request message for the selected outgoing message, and transmits the delete request message. In the delete request message, “011-444-5555” is filled in sender ID 210, “011-111-2222” in receiver ID 220, “0001” in message ID 230, and “Delete” in message type 240.

Upon receipt of the delete request message, a receiver's mobile phone deletes a received short message having a message ID of “0001” and a sender ID of “011-444-5555” in its incoming mail box. More preferably, the receiver's mobile phone first checks the read time of the short message. Only if the short message is unread will the receiver's mobile phone delete the short message. If the short message has already been read, the receiver's mobile phone transmits a deletion unavailable notification message to the sender's mobile phone.

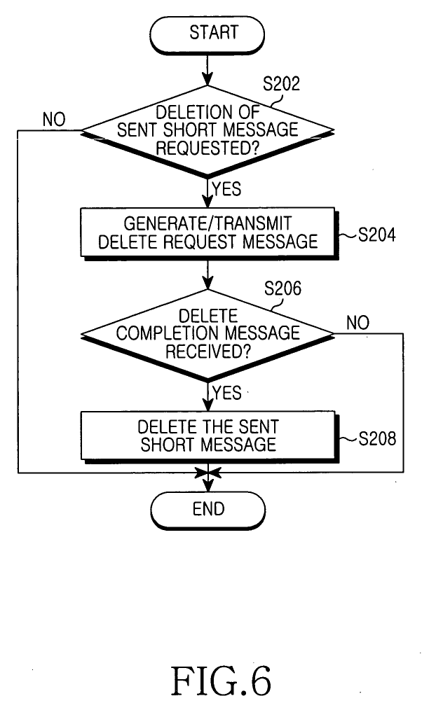

FIG. 6 is a flowchart illustrating an operation in a sender's mobile phone for deleting a short message stored in a receiver's mobile phone according to the embodiment of the present invention.

Referring to FIG. 6, when the sender requests deletion of a sent short message, for example by selecting one of the short messages stored in the outgoing mail box in step S202, the sender's mobile phone generates a delete request message based on information related to the short message and transmits the delete request message to the receiver's mobile phone in step S204. The delete request message is formatted as illustrated in FIG. 5.

Upon receipt of a delete completion message from the receiver's mobile phone in step S206, the sender's mobile phone deletes the short message in the outgoing mail box in step S208. More preferably, if the receiver has already read the short message, the receiver's mobile phone transmits a deletion unavailable notification message to the sender's mobile phone instead of the delete completion message. In this case, the receiver's mobile phone leaves the short message undeleted.

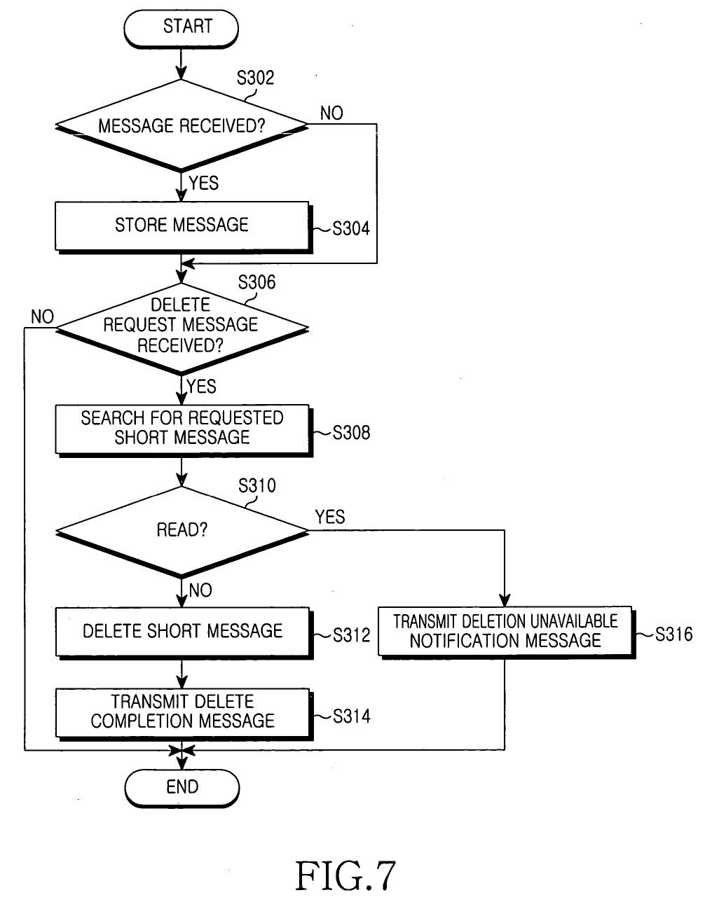

FIG. 7 is a flowchart illustrating an operation in a receiver's mobile phone for deleting a received short message according to the embodiment of the present invention.

Referring to FIG. 7, upon receipt of a short message in step S302, the receiver's mobile phone stores it in its incoming mail box in step S304. The short message is stored as illustrated in FIG. 4. Upon receipt of a delete request message for the stored short message in step S306, the receiver's mobile phone selects the short message from the incoming mail box in step S308. In step S310, the receiver's mobile phone determines if the receiver has already read the short message. If the receiver has already read the short message, the receiver's mobile phone transmits a deletion unavailable notification message to the sender's mobile phone in step S316. Otherwise, the receiver's mobile phone deletes the short message in step S312 and transmits to the sender's mobile phone a delete completion message for the short message in step S314.

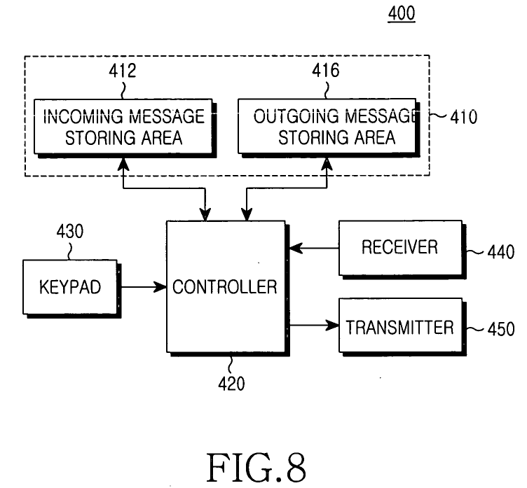

FIG. 8 is a block diagram of a mobile phone according to the embodiment of the present invention. Referring to FIG. 8, a mobile phone 400 according to the embodiment of the present invention comprises a memory 410, a controller 420, a keypad 430, a receiver 440 and a transmitter 450.

The memory 410 includes an incoming message storing area 412 for storing incoming short messages therein and an outgoing message storing area 416 for storing sent short messages therein. The received short messages are stored in the incoming message storing area 412 with information indicating if the short messages have been read, and the sent short messages are stored the outgoing message storing area 416 with information about them in. The incoming message storing area 412 and the outgoing message storing area 416 stores data in formats illustrated in FIGS. 3 and 4, respectively.

The keypad 430 receives selection information by user's key manipulation.

The controller 420, upon input of user selection information through the keypad 430, generates a delete request message for a sent message based on the selection information and transmits the delete request message through the transmitter 450. Upon receipt of a delete completion message for the delete request message through the receiver 460, the controller 420 deletes the information related the short message in the outgoing message storing area 416 of the memory 410.

Upon receipt of a delete request message for a received short message, the controller 420 searches for the received short message in the incoming message storing area 412 of the memory 410 and controls deletion of the short message. It is preferable that the controller 420 further performs the step of determining if the short message has been read. That is, the controller 420 deletes the short message only when the short message has not been read. If the short message has been read, the controller 420 generates a deletion unavailable notification message and transmits it to a mobile phone that transmitted the delete request message. If the short message has already been deleted, the controller 420 generates a delete completion message and transmits it.

In accordance with the present invention as described above, a sender's mobile phone can delete a sent short message stored in a receiver's mobile phone, which saves time that might otherwise be used by a receiver to read the wrong short message and saves memory space that might otherwise be occupied for storing the wrong short message.

While the invention has been shown and described with reference to a certain preferred embodiment thereof, it will be understood by those skilled in the art that various changes in form and details may be made therein without departing from the spirit and scope of the invention as defined by the appended claims.

1. A method of transmitting and deleting a short message, comprising the steps of:
(1) generating a short message, transmitting the short message, and storing transmission-related information about the short message in a sender's mobile phone;
(2) storing the short message in a receiver's mobile phone;
(3) transmitting from the sender's mobile phone a delete request message to the receiver's mobile phone, requesting deletion of the short message;
(4) searching in the receiver's mobile phone for the short message in response to the delete request message; and
(5) deleting the short message from the receiver's mobile phone.

2. The method of claim 1, further comprising the step of transmitting a delete completion message to the sender's mobile phone by the receiver's mobile phone after step (5).

3. The method of claim 2, further comprising the step of deleting from the sender's mobile phone the short message in a storage area in response to the delete completion message.

4. The method of claim 1, further comprising the step of determining if a receiver has already read the short message in the receiver's mobile phone, wherein only if the receiver did not read the short message until the short messages be deleted.

5. The method of claim 4, further comprising the step of transmitting a deletion unavailable notification message to the sender's mobile phone by the receiver's mobile phone, if the receiver has already read the short message.

6. The method of claim 2, further comprising the step of determining if a receiver has already read the short message in the receiver's mobile phone, wherein only if the receiver did not read the short message until the short messages be deleted.

7. The method of claim 6, further comprising the step of transmitting a deletion unavailable notification message to the sender's mobile phone by the receiver's mobile phone, if the receiver has already read the short message.

8. The method of claim 3, further comprising the step of determining if a receiver has already read the short message in the receiver's mobile phone, wherein only if the receiver did not read the short message until the short messages be deleted.

9. The method of claim 8, further comprising the step of transmitting a deletion unavailable notification message to the sender's mobile phone by the receiver's mobile phone, if the receiver has already read the short message.

10. The method of claim 1, wherein step (1) further comprises the step of storing transmission-related information related to the short message including an ID (Identification), receiver information, a transmission time, and message contents of the short message in an outgoing message storing area in the sender's mobile phone.

11. The method of claim 1, wherein step (1) further comprises the step of storing transmission-related information related to the short message including one of a title and an abstract, an ID, receiver information, and a transmission time of the short message in an outgoing message storing area in the sender's mobile phone.

12. The method of claim 1, wherein step (2) further comprises the step of storing an ID, sender information, a received time, message contents, and a read time of the short message in an incoming message storing area in the receiver's mobile phone.

13. The method of claim 1, wherein the delete request message contains a message ID, a sender ID, a receiver ID, and a message type of the short message.

14. A mobile phone having a memory for storing received short messages, comprising:
a receiver for receiving a delete request message for a short message from a sender's mobile phone that transmitted the short message; and
a controller for searching for the short message in the memory in response to the delete request message and controlling deletion of the short message.

15. The mobile phone of claim 14, wherein the memory stores received short messages with information indicating if the respective short messages have been read, and the controller determines if the short message whose deletion is requested has been read and deletes the short message only if the short message has not been read.

16. The mobile phone of claim 15, wherein the controller transmits a delete completion message for the short message to the sender's mobile phone.

17. The mobile phone of claim 14, wherein the controller transmits a deletion unavailable notification message to the sender's mobile phone if the short message has already been read.

18. A mobile phone for generating a short message, transmitting the short message, and storing transmission-related information related to the short message, comprising:
a memory for storing transmission-related information related to sent short messages;
a controller for generating a delete request message requesting deletion of a sent short message according to user selection information; and
a transmitter for transmitting the delete request message to a receiver's mobile phone that received the short message.

19. The mobile phone of claim 18, wherein the controller controls transmission-related information related to the short message to be deleted in the memory in response to a delete completion message received from the receiver's mobile phone.

20. A mobile communication system comprising:
a sending mobile phone for generating a delete request message requesting deletion of a sent short message based on user selection information and transmitting the delete request message; and
a receiving mobile phone for storing short messages received over a mobile communication network and deleting from among the stored short messages a short message whose deletion is requested in response to the delete request message.

21. The mobile communication system of claim 20, wherein the receiving mobile phone stores the received short messages with information indicating if each short message has been read, determines if the short message whose deletion is requested has been read based on the information, and deletes the short message only when the short message has not been read.

22. The mobile communication system of claim 21, wherein the receiving mobile phone generates a delete completion message for the short message and transmits the delete completion message to the sending mobile phone.

23. The mobile communication system of claim 21, wherein the receiving mobile phone transmits a deletion unavailable notification message for the short message to the sending mobile phone if the short message has already been read.

24. The mobile communication system of claim 22, wherein the sending mobile phone stores transmission-related information related to sent short messages and deletes transmission-related information about the short message whose deletion is requested in response to the delete completion message.
